(19) United States
(12) Patent Application Publication
(10) Pub. No.: US 2013/0033228 A1
(43) Pub. Date: Feb. 7, 2013

(54) METHOD AND APPARATUS FOR INDUCTIVELY TRANSFERRING AC POWER BETWEEN A CHARGING UNIT AND A VEHICLE

(71) Applicant: Steven Raedy, Raleigh, NC (US)

(72) Inventor: Steven Raedy, Raleigh, NC (US)

(73) Assignee: Evatran LLC, Wytheville, VA (US)

(21) Appl. No.: 13/198,824

(22) Filed: Aug. 5, 2011

(51) Int. Cl. H02J 7/00

(52) U.S. Cl. 320/108

(57) ABSTRACT

An inductive charging system for vehicle battery chargers includes a transformer having a stationary primary coil and a secondary coil mounted on the vehicle. The primary coil is mounted in a charging station and has a power source connected therewith. When the vehicle is parked adjacent to the charging station, the secondary coil on the vehicle is proximate to the primary coil in the station. The power source is activated to deliver current to the primary coil which generates a magnetic field to induce a voltage in the secondary coil. A controller is connected with the power source to adjust the voltage delivered to the primary coil. A feedback loop between the secondary coil and the controller delivers a secondary voltage signal to the controller which continuously adjusts the power source in order to maintain the secondary output voltage at a predetermined value.

### BACKGROUND OF THE INVENTION

Electric vehicle energy storage systems are normally recharged using direct contact conductors between an alternating current (AC) source such as is found in most homes in the form or electrical outlets; nominally 120 or 240 VAC. A well known example of a direct contact conductor is a two or three pronged plug normally found with any electrical device. Manually plugging a two or three pronged plug from a charging device to the electric automobile requires that conductors carrying potentially lethal voltages be handled. In addition, the conductors may be exposed, tampered with, or damaged, or otherwise present hazards to the operator or other naïve subjects in the vicinity of the charging vehicle. Although most household current is about 120 VAC single phase, in order to recharge electric vehicle batteries in a reasonable amount of time (two-four hours), it is anticipated that a connection to a 240 VAC source would be required because of the size and capacity of such batteries. Household current from a 240 VAC source is used in most electric clothes dryers and clothes washing machines. The owner/user of the electric vehicle would then be required to manually interact with the higher voltage three pronged plug and connect it at the beginning of the charging cycle, and disconnect it at the end of the charging cycle. The connection and disconnection of three pronged plugs carrying 240 VAC presents an inconvenient and potentially hazardous method of vehicle interface, particularly in inclement weather.

In order to alleviate the problem of using two or three pronged conductors, inductive charging systems have been developed in order to transfer power to the electric vehicle. Inductive charging, as is known to those of skill in the art, utilizes a transformer having primary and secondary windings to charge the battery of the vehicle. The primary winding is mounted in a stationary charging unit where the vehicle is stored and the secondary winding is mounted on the vehicle

There is a time varying aspect to the AC voltage, and hence there is a time-varying aspect to the magnetic fields in both the primary and secondary transformer cores. Typically, house current in the U.S. operates at about 60 hertz (Hz), or cycles per second. The problem with using a voltage that oscillates at 60 Hz, is that the size of the components in an inductive charging system is inversely proportional to the frequency, and thus the lower the frequency of the voltage, the greater the size of the inductive charging system. Size is extremely critical to vehicle manufacturers because it is very important to automotive owners. The size and weight of an object directly affects the fuel mileage of the vehicle. Thus in other inductive charging systems, high frequency voltages, normally above 10 kHz, have been used to transfer power by radiation and tuned coils.

The present invention relates to inductive proximity charging. More particularly, the invention relates to a system and method for increasing the efficiency of a gapped transformer used in inductive charging of a vehicle and for regulating the load voltage of the transformer.

### BRIEF DESCRIPTION OF THE PRIOR ART

Inductive vehicle charging systems are well known in the patented prior art as evidenced by the US patents to Bolger et al U.S. Pat. No. 4,800,328 and Farkas U.S. Pat. No. 7,880,337. The Bolger et al patent, for example, discloses a vehicle charging system wherein a capacitor connected with a secondary coil. The capacitor is in electrical communication with the coil to form a tuned circuit that is below resonance at the coupling operating frequency.

While the prior devices operate satisfactorily, they do not adequately compensate for inefficiency resulting from misalignment of the secondary and primary vehicles. Efficiency of the inductive coupling is maximized when the secondary coil is properly aligned with the stationary primary coil. However, because the secondary coil is mounted on the vehicle, optimum alignment of the vehicle with a charging station is not always attained. In such cases, the ability to adjust the power source applied to the primary coil can compensate for inductive losses resulting from misalignment of the transformer coils. The present invention was developed in order to provide such an adjustment and to reduce the net system impedance when a load such as a battery charger is connected with the secondary coil.

### SUMMARY OF THE INVENTION

Accordingly, it is a primary object of the invention to provide an efficient inductive charging system for a battery charger on an electric vehicle. The system includes a transformer having a stationary primary coil and a secondary coil mounted on the vehicle. A power source is connected with the transformer primary coil to generate a magnetic field which induces voltage in the secondary coil. A capacitor is connected in series with the secondary coil in order to compensate for the leakage inductance between the primary and secondary coils. A controller is connected with the power source for adjusting the voltage delivered to the primary coil, and a feedback loop is provided between the secondary coil and the controller for delivering a secondary voltage signal to the controller. The controller continuously adjusts the power source in order to vary the magnetic field generated by the transformer primary coil so that the secondary output voltage is maintained at a predetermined value.

The feedback loop includes a radio frequency communication device for wireless transmission of the secondary voltage signal to the controller.

The power source includes a sinusoidal voltage source and a power converter connected between the sinusoidal voltage source and the transformer primary coil. The power converter converts the sinusoidal voltage from the power source to a variable output which is delivered to the primary coil. The controller establishes a resonant frequency for the charging system to accommodate for variations in leakage reactance and series capacitance, thereby to maximize the efficiency of power transfer from the stationary primary coil to the vehicle secondary coil.

### BRIEF DESCRIPTION OF THE FIGURES

Other objects and advantages of the present invention will become apparent from a study of the following specification when read in conjunction with the accompanying drawing, in which:

FIG. 1 is a schematic diagram of the inductive vehicle charging system according to the invention; and

FIG. 2 is a detailed block diagram of the charging system of FIG. 1.

### DETAILED DESCRIPTION

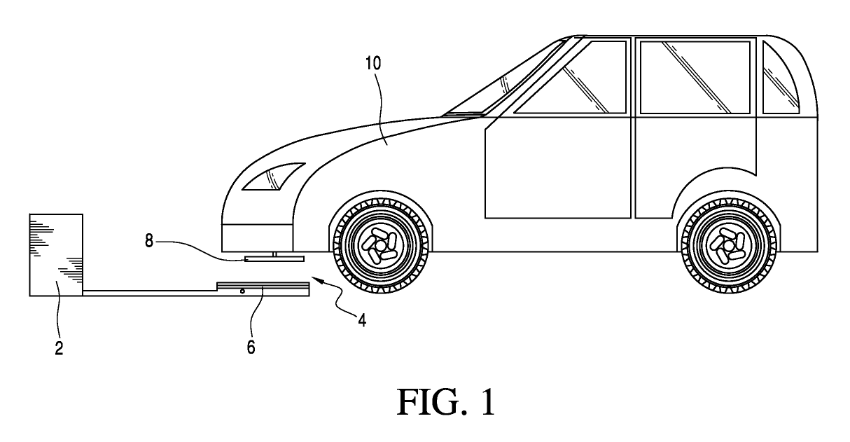

Referring first to FIG. 1, the inductive charging system according to the invention will be described. The system includes a charging station 2 and transformer 4. The transformer includes a stationary primary coil 6 which is preferably mounted on the ground such as the floor of a garage. The primary coil is connected with the charging station. The transformer further includes a secondary coil 8 which is mounted on a vehicle 10. The secondary coil is mounted at a location on the vehicle so that the vehicle can be positioned adjacent to the charging station with the secondary coil above the primary coil as shown. Preferably, the coils are arranged with their axes in alignment for maximum energy transfer. However, because axial alignment is imprecise, the inductive charging system according to the invention is designed to adjust the charging station to maximize energy transfer.

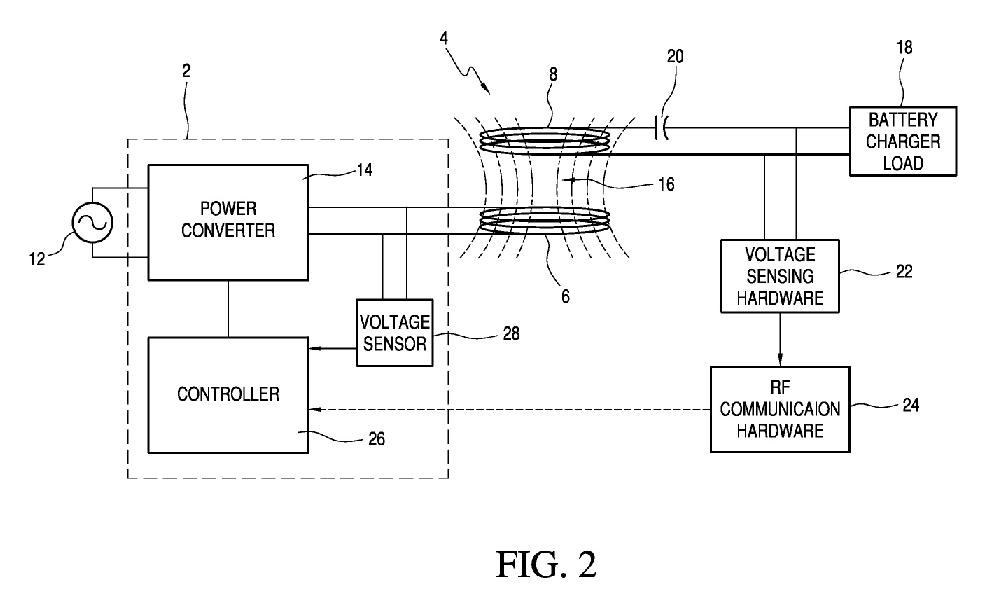

The inductive charging system according to the invention will be described in greater detail with reference to FIG. 2. The charging station 2 is connected with a power source 12. The power source is preferably a 220 volt AC supply operating at between 50 and 60 Hz. The charging station includes a power converter 14 which is capable of converting the incoming source voltage from the power supply into a voltage of arbitrary frequency and voltage. The voltage is supplied to the stationary primary coil 6. Current within the primary coil generates a magnetic field 16 which induces a current in the secondary coil 8 mounted on the vehicle. This in turn produces an output voltage which is delivered to a battery charger 18 in the vehicle to charge the vehicle battery.

An AC capacitor 20 is connected in series with the secondary coil 8 to create a resonant circuit in order to efficiently transfer energy within the transformer and to regulate the load voltage. The resonant circuit is between the transformer leakage inductance and the capacitor. Such a circuit is useful when the transformer leakage inductance is large, as is the case for the coil arrangement according to the invention, and must be cancelled by the capacitor in order to prevent an unacceptable voltage drop when the battery charger load is applied.

The primary coil is preferably energized at a frequency corresponding to the resonant frequency of the primary-to-secondary coil leakage inductance and the series connected capacitor. In this case, the no load voltage at the output of the transformer will equal the input voltage multiplied by the secondary-primary turns ratio and by the coupling factor between the coils. As the secondary coil is loaded, the voltage drop at the load will be only that due to the primary and secondary winding resistance, assuming that the primary coil is excited with a constant voltage. However, there are many factors which alter this ideal scenario.

The coupling factor between the primary and secondary coils, which dictates the output voltage of the transformer, depends on the relative alignment between the coils with respect to both the axial and radial positions of the coils. If the primary coil is energized at 220V AC for example, the secondary voltage at no load may be 220V AC at a gape of three inches and perfect radial alignment. However, if the radial alignment is off by one-third of the diameter of the coils, the secondary voltage will be significantly lower. The secondary voltage might be below the acceptable range for the load or might result in excessive secondary coil current, thereby reducing the efficiency of the inductive charging system. It is therefore desirable to maintain a regulated voltage at the load for reasonable radial and axial misalignments of the coils.

According to the invention, reductions in the secondary voltage may be compensated by adjusting the power input. Accordingly, a voltage sensor 22 is connected with the output of the secondary coil 8 and the capacitor 20. The voltage sensor 22 generates a secondary voltage signal. A radio frequency (RF) communication device 24 is connected with the voltage sensor 22 and delivers the secondary voltage signal to a controller 26 within the charging station 2 via a feedback loop. The controller continuously adjusts the voltage applied to the primary coil in accordance with the secondary voltage so that the secondary voltage is maintained at a fixed value. Thus, the output voltage is maintained at an acceptable level regardless of misalignment of the coils or various in the gap between the coils. The controller also compensates for the resistive voltage drop as the battery charger load is applied to the inductive charging system. A voltage sensor 28 connected with the output of the power converter 14 delivers a signal corresponding to the voltage output of the power converter to the controller for further adjustment of the power converter to maintain an adequate voltage supply to the system transformer.

In addition to the normal variations in coupling factors that must be accommodated, the inductive charging system must be able to accommodate variation in both leakage reactance and series capacitance, which define the resonant frequency of the system. Variations in leakage reactance will arise due to differences in coil geometries and due to steel or conductive material which is introduced into the magnetic path as a result of application of the coil to the vehicle. Variations in capacitance also occur over time as the capacitor ages.

In order to adjust for these variations in system resonant frequency, an algorithm is used in the controller to adjust the frequency of the voltage applied to the primary coil. At the resonant frequency of the system, the ratio between the output voltage and input voltage will be at a maximum for a given current level. The control system can maintain the excitation voltage frequency at the resonant frequency by periodically applying slight variations to the excitation frequency and then measuring the output to input voltage ratio. By comparing the ratio before the adjusted frequency with the ratio at the new frequency, an appropriate adjustment can be made to the excitation voltage frequency. Because the resonant frequency will not, in any practical application, vary by more than approximately 10-20% from a nominal value, the adjustments to the excitation voltage frequency would need to be relatively minor and performed relatively infrequently in order to maintain the optimal value. It will be apparent to those of ordinary skill in the art that there are a number of algorithms which may be utilized to implement this iterative technique for maintaining the system resonance.

In a preferred embodiment, a diode rectifier feeding a DC capacitor bank is connected to the output of the secondary coil. This improves the power factor of the load, resulting in a sinusoidal current with a near unity power factor which increases the efficiency of the entire system. This also provides a mechanism for absorbing the energy stored in the capacitor without resulting in high output voltage if the load is disconnected.

According to a preferred embodiment, the current rating of the secondary coil and capacitor are appropriate to withstand the continuous current required for typical automotive battery charger loads. This corresponds to approximately 8A for a 3.3 kW 400VDC charger and approximately 16A for a 6.6 kW 400VDC charger.

While the preferred forms and embodiments of the present invention have been illustrated and described, it will be readily apparent to those skilled in the art that various changes and modifications may be made without deviating from the inventive concepts set forth above.

What is claimed is:

1. An inductive charging system for a battery charger on a vehicle, comprising
(a) a transformer including a stationary primary coil and a secondary coil mounted on the vehicle;
(b) a power source connected with said transformer primary coil to generate a magnetic field which induces voltage in said secondary coil;
(c) a controller connected with said power source for adjusting the voltage delivered to said primary coil; and
(d) a feedback loop between said secondary coil and said controller for delivering a secondary voltage signal to said controller, said controller continuously adjusting said power source in order to maintain the secondary output voltage at a predetermined value.

2. An inductive charging system as defined in claim 1, and further comprising a capacitor connected in series with said secondary coil in order to compensate for the transformer leakage inductance when the battery charger load is connected with said secondary coil.

3. An inductive charging system as defined in claim 2, wherein said feedback loop comprises a radio frequency communication device for wireless transmission of said secondary voltage signal to said controller.

4. An inductive charging system as defined in claim 3, wherein said power source comprises a voltage source and a power converter connected between said voltage source and said transformer primary coil.

5. An inductive charging system as defined in claim 4, wherein said power converter converts voltage from said source to an output voltage of arbitrary voltage and frequency which is applied to said primary coil.

6. An inductive charging system as defined in claim 3, wherein said controller establishes a resonant frequency for the charging system to accommodate for variations in leakage reactance and series capacitance, thereby to maximize the efficiency of power transfer from the stationary primary coil to the vehicle secondary coil.
